(19) United States
(12) Patent Application Publication
(10) Pub. No.: US 2010/0058669 A1
(43) Pub. Date: Mar. 11, 2010

(54) GARAGE DOOR POWER MANAGEMENT SYSTEM

(76) Inventor: Ricky L. Cole, Glendale, AZ (US)

Correspondence Address: MESCHKOW & GRESHAM, P.L.C., 5727 NORTH SEVENTH STREET, SUITE 409, PHOENIX, AZ, 85014, US

(21) Appl. No.: 12/207,411

(22) Filed: Sep. 9, 2008

(51) Int. Cl. E05F 15/00

(52) U.S. Cl. 49/199; 49/506

(57) ABSTRACT

A garage door power management system (20) with at least one pivotally attached cable guide (24) controls how a power extension cable (26) extends from a reel (22) to a power management device (40). The reel (22) continuously urges retraction of the power extension cable (26), and the cable guide (24) holds the power extension cable (26) such that the tension on the power extension cable (26) is relieved at the power management device (40).

### TECHNICAL FIELD OF THE INVENTION

The present invention relates to the field of electrical power in garages. More specifically, the present invention relates to the field of systems to manage electrical power in garages.

### BACKGROUND OF THE INVENTION

Garage doors are traditionally fashioned such that individuals can roll them along tracks to open and close them. Often, lights are placed in garages to provide illumination. These lights are traditionally placed on the ceiling of the garage. In the case where the garage door opens towards the ceiling, finally resting parallel to the ceiling, the garage light is often covered by the garage door, substantially reducing the effectiveness of the light.

There have been methods developed to provide illumination in such situations. One way is to provide a light on the garage door itself. Power is traditionally provided to such a light through the use of a power extension cable from a pre-existing power outlet, such as one traditionally found on the ceiling of a garage. Since the source end of the cable is typically fixed but the destination of the cable moves with the garage door, two challenges are presented. One challenge is interference into the garage itself. In other words, the cable provides the requisite power, however it often hangs directly from the power outlet, extending directly to the light. This not only increases the appearance of clutter, but also decreases the safety of individuals walking or working in the garage.

Another challenge concerns repetitive movement of the cable as the garage door opens and closes. When opening and closing the garage door, the cable providing power to the light on the garage door may bend, making it more difficult for storage and use. This can also increase the likelihood that the cable may become damaged due to the repetitive bending. If the cable is damaged, a risk of electrical shock or of blowing a circuit breaker may result, and the user will need to replace the cable, or possibly the entire lighting system.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows an oblique side view depicting a garage including a garage door power management system in accordance with a preferred embodiment of the present invention;

FIG. 2 shows a one possible configuration for a power management device in accordance with a preferred embodiment of the present invention;

FIG. 3 shows a side view depicting a garage door in open and closed configurations in accordance with a preferred embodiment of the present invention;

FIG. 4 shows a side view depicting a garage door power management system in accordance with an alternative preferred embodiment of the present invention;

FIG. 5 shows a side view depicting a garage door opener arm in accordance with an alternative preferred embodiment of the present invention; and

FIG. 6 shows a perspective view depicting a cable guide used by a garage door power management system in accordance with a preferred embodiment of the present invention.

### DETAILED DESCRIPTION OF THE PREFERRED EMBODIMENTS

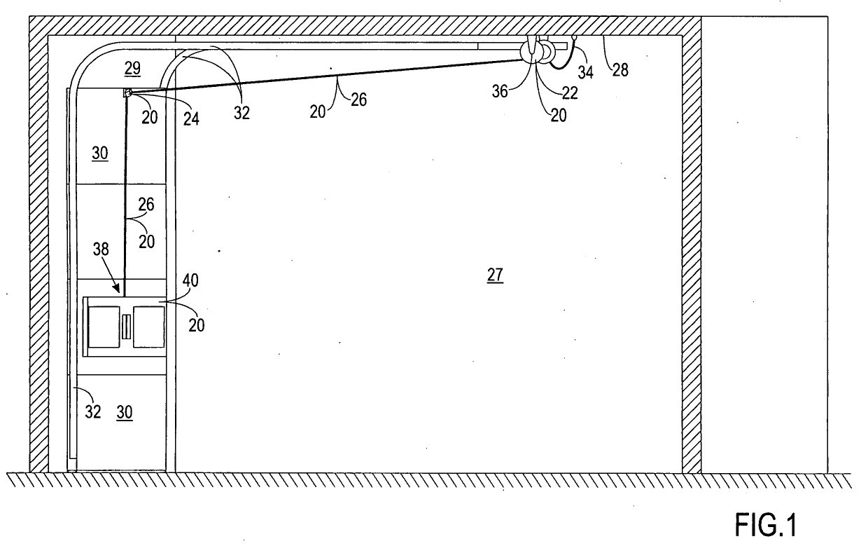

FIG. 1 shows an oblique side view depicting a garage door power management system 20. Garage door power management system 20 is made up of a reel 22, a cable guide 24, and a power extension cable 26. Garage door power management system 20 is adapted for use with a garage 27, garage 27 having a ceiling 28, a wall 29, and a garage door 30. Garage 27 is not limited to enclosures that are used to store vehicles, but includes any enclosure that can be entered or exited through the use of a door that functions as garage door 30 does.

Garage door 30 is mounted along tracks 32 so that garage door 30 can slide along tracks 32. Tracks 32 are oriented such that when garage door 30 is closed, garage door 30 is perpendicular to ceiling 28, but when garage door 30 is open, garage door 30 is parallel with ceiling 28. Although garage door 30 is described here as an overhead garage door, garage door 30 can also be a carriage door which is configured such that tracks 32 run parallel to wall 29, and garage door is perpendicular to ceiling 28 both when open and closed.

Reel 22 is attached to ceiling 28 in a manner that allows power extension cable 26 to be wound around reel 22 for storage when garage door 30 is opened, and to be released as needed when garage door 30 is closed. Reel 22 can be further configured to continuously urge the retraction of power extension cable 26, thus placing power extension cable 26 under constant tension. For example, a spring (not shown) within reel 22 may be wound as reel 22 rotates in a first direction (i.e. clockwise or counterclockwise) to feed power extension cable 26 off of reel 22. The spring then continuously urges reel 22 to rotate in a second direction which opposes the first direction (i.e. counterclockwise or clockwise) that will cause power extension cable 26 to be wound onto reel 22. Desirably, no ratcheting mechanism (not shown) is included in reel 22, or any ratcheting mechanism in reel 22 is disabled, so that reel 22 does not lock at any position, but continuously urges the retraction of power extension cable 26. Reel 22 has a plug end 34 that plugs into a wall power outlet and provides power to power extension cable 26.

Although it is desirable that reel 22 be configured to continuously urge the retraction of power extension cable 26, other methods may be used to retract power extension cable 26 within reel 22. Such other methods may include manually retracting power extension cable 26 when garage door 30 is opened and manually extending power extension cable when garage door 30 is closed. Other automatic methods, may also employ a retraction system that will only urge retraction of power extension cable 26 at the time garage door 30 opens, urging the retraction at the same rate at which garage door 30 opens.

Power extension cable 26 has a first end 36 attached to the interior of reel 22, and a second end 38 that passes from reel 22 and through cable guide 24. First end 36 may be attached to reel 22 through a two-prong power plug, a grounding three-prong plug, or any other method by which electricity can be provided to power extension cable 26. Second end 38 is attached to power management device 40, which is attached to garage door 30 such that power management device 40 is within garage 27 when garage door 30 is closed.

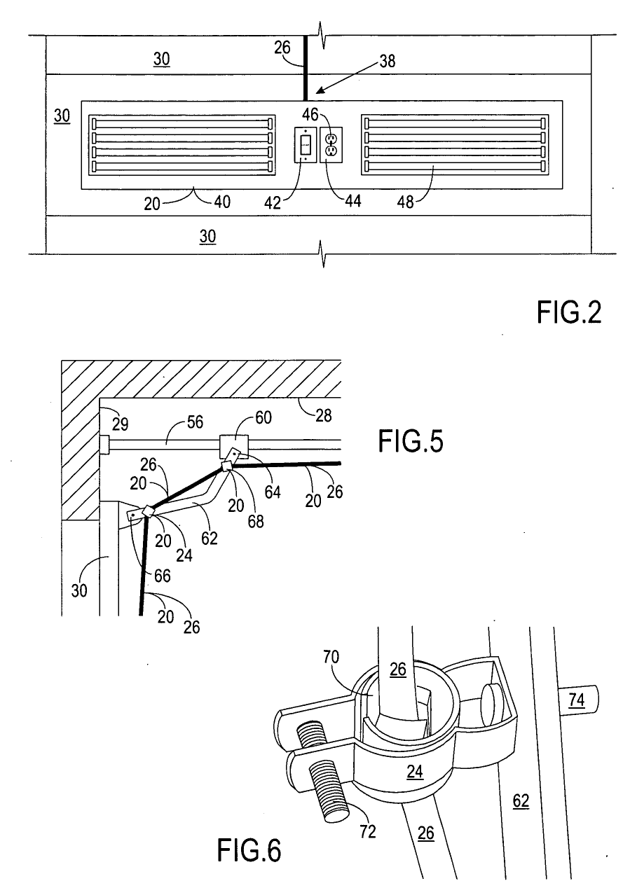

FIG. 2 shows one possible configuration for power management device 40. Power management device 40 may be a switch 42, power outlet 44, a female plug socket 46, light 48, and/or other unit or device that manages or directly uses electricity. Furthermore, power management device 40 may also be a combination of any number of switch 42, power outlet 44, female plug socket 46 and light 48 mounted on garage door 30. It should be noted that if power management device 40 is made up of multiple subparts, such adaptations can be made while still powering the overall power management device 40 through power extension cable 26. Although switch 42 can be any traditional switch, it is desirable that switch 42 be a paddle switch in which there is a switching lever that is parallel to garage door 30. This configuration allows switch 42 to be easily operated by an individual with a push rod when garage door 30 and switch 42 are overhead.

Cable guide 24 is pivotally attached to garage door 30, such that once power extension cable 26 has passed through cable guide 24, power extension cable 26 lies parallel to garage door 30. Cable guide 24 is configured to pivot freely along an axis that is perpendicular to the direction of travel of garage door 30 as it is opened and closed.

Cable guide 24 is attached to power extension cable 26 as it passes through cable guide 24. It is desirable to have cable guide 24 clamp around power extension cable 26, due to the constant tension on power extension cable 26 due to reel 22. By clamping around power extension cable 26 in this way, cable guide 24 also opposes substantially all retraction tension applied on power extension cable 26 by reel 22, allowing little or no tension to be transmitted to second end 38 where it could interfere with connections with power management device 40.

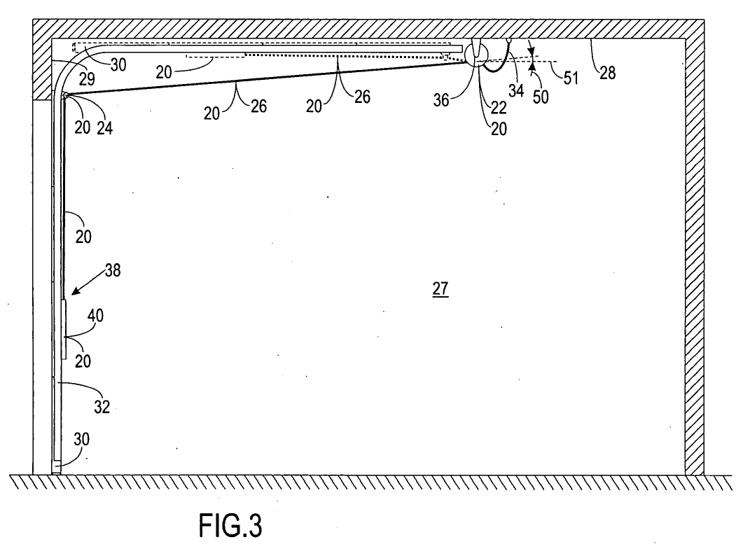

FIG. 3 shows garage door 30 in open and closed configurations. The closed configuration is depicted using dashed lines, and the open configuration is depicted using solid lines. An angle 50 is formed between an imaginary horizontal line 51 parallel to ceiling 28 and power extension cable 26 at reel 22. By placing cable guide 24 near the top of garage door 30, angle 50 is nearly constant, reducing the stress on reel 22.

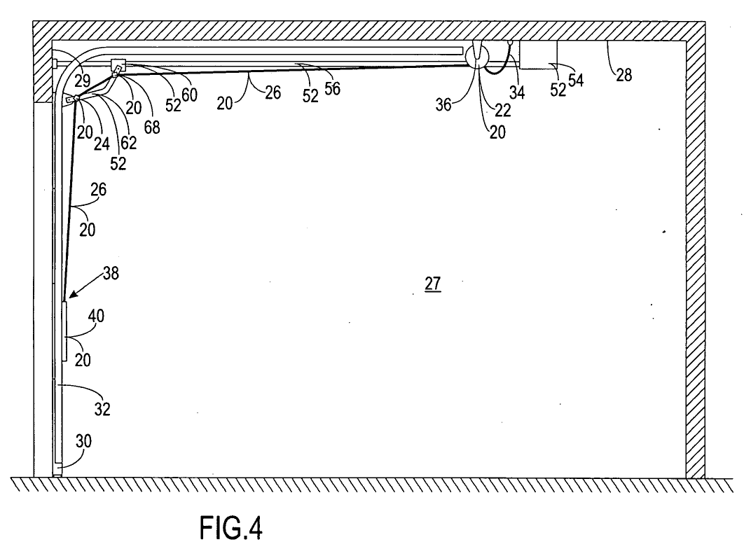

FIG. 4 shows an side view depicting garage door power management system 20. In this embodiment, garage door power management system 20 is made up of reel 22, a first cable guide 24, a second cable guide 68, and power extension cable 26. Here, reel 22 is attached to ceiling 28, and power extension cable 26 comes from reel 22, passes through second cable guide 68, and first cable guide 24, terminating in power management device 40.

A garage door opener 52 is used to open and close garage door 30. Garage door opener 52 is made up of a power unit 54, a trolley guide 56, a releasable trolley 60, and an opening arm 62. Power unit 54 is attached to ceiling 28 proximate to reel 22. Trolley guide 56 has one end attached to power unit 54, a second end attached to garage wall 29 above garage door 30, and a trolley moving mechanism (not shown) within it. Releasable trolley 60 is attached to trolley guide 56 such that releasable trolley 60 can be moved along trolley guide 56 from power unit 54 to garage wall 29 by the trolley moving mechanism. Opening arm 62 has a first end 64 attached to releasable trolley 60, and a second end 66 is pivotally attached to garage door 30 (FIG. 1). As releasable trolley 60 travels along trolley guide 56 away from power unit 54, opening arm 62 is pushed away from power unit 54, and garage door 30 is closed. As releasable trolley 60 travels along trolley guide away from garage wall 29 towards power unit 54, opening arm 62 is pulled toward power unit 54, and garage door 30 is pulled open. The movement of releasable trolley 60 towards and away from power unit 54 is controlled by an individual, if releasable trolley 60 is released from the trolley moving mechanism, or by power unit 54 if releasable trolley 60 is attached to the trolley moving mechanism.

FIG. 5 shows a side view of first cable guide 24 and second cable guide 68 in garage door power management system 20. First cable guide 24 is pivotally attached to second end 66 of opening arm 62, near the top of garage door 30. Second cable guide 68 is attached to releasable trolley 60. Both first cable guide 24 and second cable guide 68 hold power extension cable 26 as described in FIG. 1. Having second cable guide 68 pivotally attached to first end 64 of opening arm 62, at releasable trolley 60 further ensures that angle 50 (FIG. 3) remains constant at all times, regardless of whether garage door 30 is being opened or closed. This is because releasable trolley 60 will be travelling parallel to ceiling 28 over the full distance of trolley guide 56, and thus the vertical distance between second cable guide 68 and ceiling 28 will always be constant. Similarly, the vertical distance between reel 22 and ceiling 28 will always be constant. As a result, angle 50 from horizontal at the reel opening will always be constant.

FIG. 6 shows a perspective view of cable guide 24. It should be noted that although the following discussion specifically describes cable guide 24, second cable guide 68 is of the same structure as cable guide 24 in the preferred embodiment. Cable guide 24 has an internal molding 70 that holds power extension cable 26 as it passes through cable guide 24. In one embodiment, cable guide 24 is fabricated such that the force exerted upon power extension cable 26 may be adjusted to adapt to the thickness and material of power extension cable 26. In this embodiment, this adjustment is made through screw 72, which controls the spacing between two sides of cable guide 24. The spacing is adjusted such that cable guide 24 can clamp around power extension cable 26 so that cable guide 24 opposes substantially all retraction tension that is applied on power extension cable 26 by reel 22. Those skilled in the art will recognize that internal molding 70 can be replaced with any other method of controlling the force cable guide 24 exerts upon power extension cable 26.

Cable guide 24 is pivotally attached to either garage door 30 or second end 66 of opening arm 62. In one embodiment, this attachment is made with the use of pivot pin 74. Pivot pin 74 is traditionally used to secure first end 64 of opening arm 62 to garage door 30. A second pivot pin 74 is used to secure first end 64 of opening arm 62 to releasable trolley 60. In one embodiment of the invention, pivot pin 74 passes through a bracket (not shown) on garage door 30 and second end 66 of opening arm 62 to cable guide 24 to pivotally hold cable guide 24 while also securing garage door 30 to opening arm 62. Similarly, second pivot pin 74 passes through releasable trolley 60 and first end 64 of opening arm 62 to second cable guide 68 to pivotally hold second cable guide 68 while also securing releasable trolley 60 to opening arm 62.

In summary, the present invention teaches a garage door power management system 20. By using cable guides 24 and 68 to guide power extension cable 26 from reel 22 to power management device 40, garage door power management system 20 controls how power extension cable 26 is managed while garage door 30 is closed, opened and moved between the closed and opened positions.

The use of cable guides 24 and 68 prevents power extension cable 26 from extending directly from reel 22 to power management device 40 and interfering with the interior space of garage 27 This promotes a method of controlling power extension cable 26 such that power extension cable 26 does not create a safety hazard.

As reel 22 is continuously urging retraction of power extension cable 26, cable guide 24 relieves tension at power management device 40. This is done by controlling the tension of power extension cable 26 so that any tension that results from reel 22 effectively terminates at cable guide 24 thus relieving the tension of power extension cable 26 at power management device 40. By holding power extension cable 26 in cable guides 24 and/or 68 that freely pivot as garage door 30 moves, power extension cable 26 is prevented from experiencing abrupt bending as garage door 30 opens and closes, thereby extending the useful life of power extension cable 26 and reducing the likelihood of exposing internal cable conductors, and of forming electrical shorts or opens.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A garage door power management system (20) comprising:
a reel (22);
a power extension cable (26) wrapped around said reel (22), said power extension cable (26) having a first end (36), wherein said first end (36) is connected to said reel (22);
a cable guide (24) pivotally attached to a garage door (30); and
wherein said power extension cable (26) attaches to said cable guide (24).

2. A garage door power management system (20) as claimed in claim 1 further comprising a pivot pin (74), wherein said cable guide (24) is pivotally attached to said garage door (30) with said pivot pin (74).

3. A garage door power management system (20) as claimed in claim 1 wherein said power extension cable (26) has a second end (38), said second end (38) being connected to a power outlet (44).

4. A garage door power management system (20) as claimed in claim 1 wherein said power extension cable (26) has a second end (38), said second end (38) being connected to a switch (42).

5. A garage door power management system (20) as claimed in claim 4 wherein said switch (42) is a paddle switch.

6. A garage door power management system (20) as claimed in claim 1 wherein said power extension cable (26) has a second end (38), said second end (38) being connected to a light (48).

7. A garage door power management system (20) as claimed in claim 6 wherein said light (48) is attached to said garage door (30).

8. A garage door power management system (20) as claimed in claim 1 wherein said cable guide (24) maintains a substantially constant angle (50) between said cable guide (24) and said reel (22) as said garage door (30) opens and closes.

9. A garage door power management system (20) as claimed in claim 1 wherein said cable guide (24) is clamped around said power extension cable (26).

10. A garage door power management system (20) as claimed in claim 1 wherein said cable guide (24) is one of a plurality of cable guides.

11. A garage door power management system (20) as claimed in claim 1, wherein said cable guide (24) is a first cable guide (24) and said garage door (30) is connected to a garage door opener (52), said garage door power management system (20) further comprising:
a second cable guide (68) pivotally attached to said garage door opener (52) so that said power extension cable (26) attaches to said second cable guide (68).

12. A garage door power management system (20) as claimed in claim 11, further comprising a second pivot pin (74) wherein said second cable guide (68) is pivotally attached to said garage door opener (52) with said second pivot pin (74).

13. A garage door power management system (20) as claimed in claim 11 wherein:
said garage door opener (52) further comprises a releasable trolley (60); and
said second cable guide (68) is pivotally attached to said releasable trolley (60).

14. A garage door power management system (20) as claimed in claim 13, wherein:
said garage door opener (52) further comprises a trolley guide (56); and
said second pivot pin (74) is configured to attach said releasable trolley (60) to said trolley guide (56).

15. A garage door power management system (20) as claimed in claim 1 wherein said reel (22) is configured to continuously urge retraction of said power extension cable (26).

16. A method of using a garage door power management system (20) on a garage door (30), wherein said garage door power management system (20) comprises a reel (22), a power extension cable (26) with a first end (36) connected to said reel (22), and a pivotal cable guide (24), said method comprising:
attaching said pivotal cable guide (24) to said garage door (30) such that said pivotal cable guide (24) rotates freely about an axis perpendicular to a direction of travel of said garage door (30);
placing said power extension cable (26) through said pivotal cable guide (24) such that said pivotal cable guide (24) holds said power extension cable (26).

17. A method as claimed in claim 16 further comprising attaching said reel (22) to a ceiling (28) in a garage (27).

18. A method as claimed in claim 16 wherein said garage door (30) is attached to a garage door opener (52), said garage door power management system (20) further comprising a second pivotal cable guide (68), said method further comprising:
attaching said second pivotal cable guide (68) to a garage door opening arm (62) such that said second pivotal cable guide (68) rotates freely along an axis perpendicular to said direction of travel of said garage door (30);
placing said power extension cable (26) such that said second pivotal cable guide (68) holds said power extension cable (26).

19. A method as claimed in claim 16 further comprising attaching said reel (22) to a ceiling (28) in a garage (27).

20. A garage door power management system (20) configured to be used with a garage door (30) and a garage door opener (52), said garage door power management system (20) comprising:
a reel (22);
a power extension cable (26) configured to be wrapped around said reel (22), said power extension cable (26) having a first end (36) connected to said reel (22);
a first cable guide (24) attached to a first end (66) of a garage door opening arm (62) of said garage door opener (52), said first end (66) of said garage door opening arm (62) being connected to said garage door (30); and
a second cable guide (68) attached to a releasable trolley (60) of said garage door opener (52);
wherein said power extension cable (26) is held by said first cable guide (24) and said second cable guide (68).
